(19) United States
(12) Patent Application Publication
(10) Pub. No.: US 2012/0250177 A1
(43) Pub. Date: Oct. 4, 2012

(54) INCREASED DATA ACCESS RATES FOR MAGNETIC HARD DISK MEDIA

(75) Inventors: Vinay Ashok Somanache, Pune (IN); Haribhai Somabhai Patel, Banskantha (IN)

(73) Assignee: LSI CORPORATION, Milpitas, CA (US)

(21) Appl. No.: 13/078,255

(22) Filed: Apr. 1, 2011

(51) Int. Cl. G11B 21/02; G11B 21/04; G11B 5/02; G11B 21/24

(52) U.S. Cl. 360/55; 360/294.1; 360/274; 360/75; G9B/21.028; G9B/21.008; G9B/21.003; G9B/5.026

(57) ABSTRACT

A method and apparatus for transferring data. First data is transferred in a first direction on a surface of a selected magnetic disk in a plurality of magnetic disks using a first actuator assembly. Second data is transferred in a second direction on the surface of the selected magnetic disk in the plurality of magnetic disks using a second actuator assembly, while the first data is being transferred in the first direction by the first actuator assembly.

### BACKGROUND OF THE INVENTION

1. Technical Field

The present disclosure is directed generally toward disk drives and, in particular, to data access systems in hard disk drives. Still more particularly, the present disclosure is related to a method and apparatus for increasing the rate at which data on magnetic disks is accessed.

2. Description of the Related Art

A disk drive is a device that stores data on magnetic media. In particular, a disk drive stores digital data on magnetic disks. These magnetic disks take the form of rigid platters that rotate on a spindle within an enclosure. Each disk is divided into magnetic regions. These regions may take the form of tracks on the disks. Data is read and written on these magnetic disks using read and write head assemblies that are moved over different locations on the magnetic disks.

Many applications require the transfer of large amounts of data to and from a hard disk drive. For example, the recording and editing of video data involves the transfer of larger amounts of data, as compared to word processing documents. Many applications also require large numbers of disk accesses to hard disk drives. A database application is an example of an application that may require large numbers of disk accesses.

These disks include magnetic media on which data may be stored. Users of applications typically want to perform different tasks and functions as quickly as possible. As a result, the speed at which data can be accessed on a disk drive is increasing. As the need for increased performance in disk drives continues to grow, currently used disk drives may not provide a desired amount of access. Therefore, it would be advantageous to have a method and apparatus that takes into account one or more of the issues discussed above, as well as other possible issues.

### SUMMARY OF THE INVENTION

In one illustrative embodiment, a disk drive comprises a plurality of magnetic disks; a first actuator assembly, and a second actuator assembly. The first actuator assembly is configured to transfer first data with the plurality of magnetic disks. The second actuator assembly is configured to transfer second data with the plurality of magnetic disks. The first actuator assembly transfers the first data in a first direction on a surface of a selected magnetic disk in the plurality of magnetic disks, while the second actuator assembly transfers the second data in a second direction on the surface of the selected magnetic disk in the plurality of magnetic disks.

In another illustrative embodiment, an apparatus comprises a number of circuits configured to control transfer of first data in a first direction on a surface of a selected magnetic disk in a plurality of magnetic disks using a first actuator assembly and transfer of second data in a second direction on the surface of the selected magnetic disk in the plurality of magnetic disks using a second actuator assembly.

In yet another illustrative embodiment, a method is provided for transferring data. First data is transferred in a first direction on a surface of a selected magnetic disk in a plurality of magnetic disks using a first actuator assembly. Second data is transferred in a second direction on the surface of the selected magnetic disk in the plurality of magnetic disks using a second actuator assembly, while the first data is being transferred in the first direction by the first actuator assembly.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a block diagram of a disk drive in accordance with an illustrative embodiment;

FIG. 2 is an illustration of actuator assemblies and magnetic disks in a disk drive in accordance with an illustrative embodiment; and

FIG. 3 is an illustration of a flowchart of a process for transferring data to and from magnetic disks in accordance with an illustrative embodiment.

### DETAILED DESCRIPTION

The different embodiments take into account a number of considerations. For example, the different illustrative embodiments recognize and take into account that with currently available disk drives, a single actuator system is typically present. The use of a single actuator system is a factor in the amount of data that can be accessed on magnetic disks in a disk drive.

The different illustrative embodiments recognize and take into account that one manner in which the speed at which data may be accessed on a magnetic disk in a disk drive may involve the use of more than one actuator assembly in the disk drive. For example, the different illustrative embodiments recognize and take into account that two actuator assemblies may be used to position read and write heads over the magnetic disks in a disk drive. The different illustrative embodiments recognize and take into account that the actuator assemblies may be used to increase the speed at which data is read. It is desirable to have the fastest rate of data access possible.

The different illustrative embodiments recognize and take into account that, with the use of two actuator assemblies, parallel reads and parallel writes can be used. These parallel reads and writes mean that data can be transferred more quickly. For example, in a parallel read, the different illustrative embodiments recognize and take into account that one actuator assembly reads data from one portion of a disk drive while another actuator assembly reads data from another portion of the disk drive. In a similar fashion, if data is written to the disk drive, part of the data may be written to one portion of the disk drive using one actuator assembly while another portion of the data may be written to a different portion of the disk drive using the second actuator assembly. In this manner, reads and writes may be performed more quickly using two actuator assemblies rather than a single actuator assembly.

The different illustrative embodiments recognize and take into account that with parallel reading and parallel writing of data, the complexity of the hard disk drive increases. For example, the different illustrative embodiments recognize and take into account that two read controllers and two write controllers are needed to perform reading and writing data in parallel.

Further, the different illustrative embodiments recognize and take into account that, in addition to requiring more logic and circuits, the complexity of controlling the reads and writes also increases. For example, if data is received to be written to the magnetic disk, firmware or other logic is needed to divide the data that is being received and send the data to the different actuator assemblies in a manner that results in a correct writing of the data to the disk. A similar type of logic or firmware is also needed to read data from the disk and send the data for use.

The different illustrative embodiments also recognize and take into account that these increases in the complexity of the disk drive require additional components or circuits. As a result, the amount of real estate needed on an integrated circuit increases when parallel reads and writes are provided through multiple actuator assemblies. Additionally, this complexity also may result in undesired increases in the cost to design and manufacture disk drives.

Thus, the different illustrative embodiments provide a method and apparatus for increasing access to magnetic disks in a disk drive. In one illustrative embodiment, an apparatus comprises a plurality of magnetic disks, a first actuator assembly, and a second actuator assembly. The first actuator assembly and the second actuator assembly are configured to transfer data with the plurality of magnetic disks. The first actuator assembly is configured to transfer the data in a first direction in the plurality of magnetic disks, while the second actuator assembly transfers the data in a second direction in the plurality of magnetic disks.

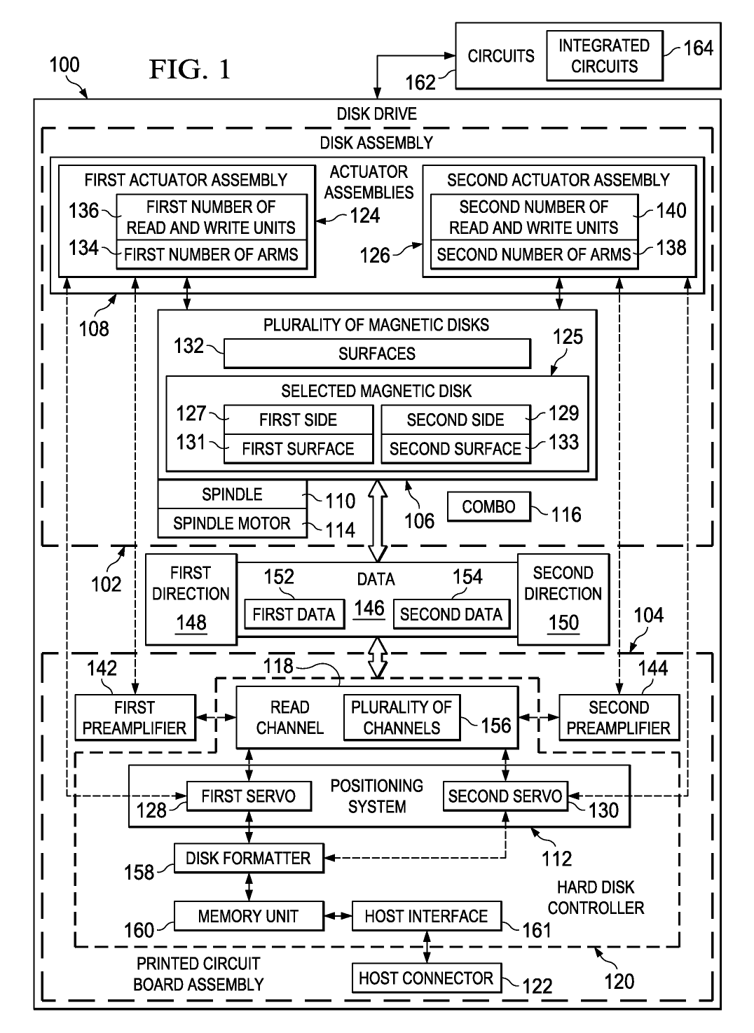

With reference now to the figures and, in particular, with reference to FIG. 1, a block diagram of a disk drive is depicted in accordance with an illustrative embodiment. Disk drive 100 may be used with various types of data processing systems. For example, disk drive 100 may be used to store data in a desk computer, a server computer, a laptop computer, a digital camera, a video camera, or some other suitable type of data processing system. Further, disk drive 100 may be implemented as an internal component within the data processing system or may be attached to the data processing system externally. In this example, disk drive 100 comprises disk assembly 102 and printed circuit board assembly 104.

As depicted, disk assembly 102 comprises plurality of magnetic disks 106, actuator assemblies 108, spindle 110, spindle motor 114, and combo 116. In this example, plurality of magnetic disks 106 is rotatably connected to spindle 110.

As used herein, when a first component is connected to a second component, the first component may be connected to the second component without any additional components. The first component may also be connected to the second component by one or more other components. For example, one electronic device may be connected to a second electronic device without any additional electronic devices between the first electronic device and the second electronic device. In some cases, another electronic device may be present between the two electronic devices connected to each other.

In this illustrative example, spindle 110 is connected to spindle motor 114. Spindle motor 114 is configured to turn spindle 110 which, in turn, causes rotation of plurality of magnetic disks 106. Combo 116 may be implemented using, for example, an integrated circuit. Combo 116 provides current to spindle motor 114 to rotate spindle 110 at a desired speed of rotation. Combo 116 is controlled by hard disk controller 120 in these depicted examples. Hard disk controller 120 performs read and write operations on plurality of magnetic disks 106 as plurality of magnetic disks 106 rotates with spindle 110.

Actuator assemblies 108 include first actuator assembly 124 and second actuator assembly 126. First actuator assembly 124 has first number of arms 134 and first number of read and write units 136. Second actuator assembly 126 has second number of arms 138 and second number of read and write units 140. As used herein, a number, when used with reference to items, means one or more items. For example, “first number of arms 134” is one or more arms.

In these illustrative examples, one or more of first number of read and write units 136 may be connected to, or otherwise associated with, an arm in first number of arms 134. In a similar fashion, one or more of second number of read and write units 140 may be connected to an arm within second number of arms 138.

Printed circuit board assembly 104 comprises hard disk controller 120 and host connector 122. In these illustrative examples, hard disk controller 120 is connected to host connector 122. Hard disk controller 120 controls the reading and writing of data 146 with respect to plurality of magnetic disks 106. Host connector 122 is configured for connection to other components in a data processing system. For example, host connector 122 may be connected to a bus or other connector in a data processing system. Host connector 122 may be, for example, without limitation, a fire wire connection, a universal serial bus connection, a peripheral inter-connect connection, or some other suitable type of connection.

As illustrated, hard disk controller 120 comprises positioning system 112, read channel 118, disk formatter 158, memory unit 160, and host interface 161. Positioning system 112 includes first servo 128 and second servo 130. A servo is a device configured to control the position of an actuator assembly. In these examples, the position is relative to a location on surfaces 132 on plurality of magnetic disks 106.

As depicted, first servo 128 is connected to first actuator assembly 124, and second servo 130 is connected to second actuator assembly 126. First servo 128 controls the movement of first actuator assembly 124 over surfaces 132 of plurality of magnetic disks 106 to move first actuator assembly 124 to a desired position over surfaces 132. In a similar fashion, second servo 130 controls the movement of second actuator assembly 126 over surfaces 132 of plurality of magnetic disks 106 to move second actuator assembly 126 to a desired position over surfaces 132.

More specifically, first servo 128 moves first number of arms 134 in a manner to position first number of read and write units 136 over surfaces 132 of plurality of magnetic disks 106. In a similar fashion, second servo 130 moves second number of arms 138 in a manner to position second number of read and write units 140 over surfaces 132 of plurality of magnetic disks 106.

In these depicted examples, first actuator assembly 124 and second actuator assembly 126 are configured to transfer data 146 with plurality of magnetic disks 106. For example, first servo 128 and second servo 130 may control first actuator assembly 124 and second actuator assembly 126 to transfer data 146 with selected magnetic disk 125 of plurality of magnetic disks 106.

In particular, selected magnetic disk 125 has first side 127 and second side 129. Selected magnetic disk 125 has first surface 131 on first side 127 and second surface 133 on second side 129. First actuator assembly 124 and second actuator assembly 126 are configured to transfer data 146 on first surface 131 and/or second surface 133 of selected magnetic disk 125. In these depicted examples, when data is transferred on a surface, the data may be written onto the surface or read from the surface.

As one illustrative example, first actuator assembly 124 is configured to transfer first data 152 in data 146 in first direction 148 on first surface 131 of selected magnetic disk 125, and second actuator assembly 126 is configured to transfer second data 154 in data 146 in second direction 150 on second surface 133 of selected magnetic disk 125. In these illustrative examples, first actuator assembly 124 transfers first data 152 in first direction 148 on first surface 131, while second actuator assembly 126 transfers second data 154 in second direction 150 on second surface 133.

In this illustrative example, the transfer of first data 152 in first direction 148 and the transfer of second data 154 in second direction 150 may be a read or a write of data. For example, if the transfer of first data 152 in first direction 148 is a read of first data 152 from selected magnetic disk 125, then the transfer of second data 154 in second direction 150 is a write of second data 154 to selected magnetic disk 125. When first direction 148 is a write of data to selected magnetic disk 125, second direction 150 is a read of data from selected magnetic disk 125.

As a result, data 146 may be read and written at the same time. In other words, simultaneous reading and writing of data 146 is provided in the different illustrative embodiments. Further, data 146 may be read and written with respect to disk drive 100 on the same magnetic disk within plurality of magnetic disks 106 or on different magnetic disks when in plurality of magnetic disks 106.

In these illustrative examples, first actuator assembly 124 and second actuator assembly 126 may transfer data 146 with selected magnetic disk 125 on first surface 131 of selected magnetic disk 125. However, in other illustrative examples, first actuator assembly 124 and second actuator assembly 126 may be configured to transfer data 146 with both first surface 131 and second surface 133 of selected magnetic disk 125 at the same time.

For example, first actuator assembly 124 may transfer first data 152 in first direction 148 on first surface 131 of selected magnetic disk 125, while second actuator assembly 126 transfers second data 154 in second direction 150 on second surface 133 of selected magnetic disk 125. In some illustrative examples, first actuator assembly 124 and second actuator assembly 126 may be configured to transfer data 146 on the surfaces of two different magnetic disks in plurality of magnetic disks 106.

In these illustrative examples, the transfer of first data 152 in first direction 148 and the transfer of second data 154 in second direction 150 is provided through the use of separate preamplifiers, servos, and actuator assemblies. Through these and other suitable components, first actuator assembly 124 and second actuator assembly 126 may be in different positions to perform a read and write at the same time.

As illustrated, read channel 118 provides an interface between printed board circuit assembly 104 and disk assembly 102 and is configured to support transfers of data 146 in first direction 148 and second direction 150. In these illustrative examples, the transfers of data 146 may take the form of read and write operations. As depicted, read channel 118 has plurality of channels 156. Plurality of channels 156 is configured such that data 146 may be written in first direction 148 and second direction 150 through plurality of channels 156 at the same time. For example, a portion of plurality of channels 156 may be configured for performing read operations, while another portion of plurality of channels 156 may be configured for performing write operations.

Read channel 118 is connected to disk formatter 158. Disk formatter 158 is configured to control reading and writing of data. For example, disk formatter 158 is configured to transfer data 146 in first direction 148 and second direction 150 at the same time. Further, disk formatter 158 is connected to positioning system 112. More specifically, disk formatter 158 is connected to first servo 128 and second servo 130.

Additionally, read channel 118 is connected to first preamplifier 142 and second preamplifier 144. First preamplifier 142 and second preamplifier 144 are configured to amplify read signals received in plurality of channels 156 from first actuator assembly 124 and second actuator assembly 126, respectively, and amplify write signals sent through plurality of channels 156 to first actuator assembly 124 and second actuator assembly 126.

Host interface 161 is connected to host connector 122 and comprises a number of logic units configured to communicate with a host through host connector 122. Further, host interface 161 is also connected to memory unit 160. In this illustrative example, memory unit 160 may be implemented using, for example, static random access memory (SRAM) and/or dynamic random access memory (DRAM). Memory unit 160 functions as a buffer for data transfer between a host and disk drive 100.

In one illustrative example, signals for performing write operations are received through host connector 122. In other words, the signals represent commands to perform a write operation and/or data that is to be written. These signals may be sent from host connector 122 to hard disk controller 120 through host interface 161. The signals are then sent to memory unit 160. In these depicted examples, memory unit 160 stores data to be written to plurality of magnetic disks 106. Memory unit 160 functions as a buffer for the data until disk formatter 158 processes the signals and data.

When the signals are sent from memory unit 160 to disk formatter 158, disk formatter 158 processes the signals for performing the write operation and sends commands to one of first servo 128 and second servo 130. In this example, disk formatter 158 sends commands to first servo 128. First servo 128 controls the position of first actuator assembly 124 to move first actuator assembly 124 to a desired position for performing the write operation. Disk formatter 158 also sends write signals through plurality of channels 156 in read channel 118. These write signals are then sent through first preamplifier 142 to first actuator assembly 124 to write the data to a magnetic disk in plurality of magnetic disks 106.

In this illustrative example, signals for performing a read operation through host connector 122 may be received in hard disk controller 120 through host interface 161 at a substantially same time as when the signals for performing the write operation are received. These signals are then sent to memory unit 160 and stored until disk formatter 158 can process the signals. When the signals are sent from memory unit 160 to disk formatter 158, disk formatter 158 processes the signals for performing the read operation and sends commands to second servo 130 in this illustrative example. Second servo 130 controls the position of second actuator assembly 126 to move second actuator assembly 126 to a desired position for performing the read operation. The position for performing the read operation cannot be the same position for performing the write operation if the two operations are to be performed on a same surface of a same magnetic disk in plurality of magnetic disks 106.

Additionally, disk formatter 158 sends read signals through plurality of channels 156 in read channel 118. These read signals are sent through second preamplifier 144 to second actuator assembly 126 to read data from a magnetic disk in plurality of magnetic disks 106. Data that is read by second actuator assembly 126 is sent to read channel 118 through second preamplifier 144. Second preamplifier 144 is configured to read the analog signals from the magnetic disk and amplify the signals before passing the signals to read channel 118. In these illustrative examples, the data that is read is then be sent through disk formatter 158, memory unit 160, host interface 161, and host connector 122 to the host that initiated the read operation.

As read channel 118 performs read and write operations, read channel 118 uses servo information written on plurality of magnetic disks 106 to monitor the position of first number of read and write units 136 and second number of read and write units 140 during read and write operations. The servo information may also be referred to as servo data or servo codes. In particular, read channel 118 reads the servo information on plurality of magnetic disks 106 during read and write operations. The servo information allows first actuator assembly 124 and second actuator assembly 126 to know the positions of first number of read and write units 136 and second number of read and write units 140 relative to plurality of magnetic disks 106.

This servo information is sent to first servo 128 and/or second servo 130. First servo 128 and second servo 130 use the servo information to determine whether changes to the speed of rotation of spindle 110 need to be made to adjust the position of first number of read and write units 136 and/or second number of read and write units 140. First servo 128 and/or second servo 130 send signals to combo 116 to control the level of current sent to spindle motor 114. Controlling the level of current causes spindle 110 to rotate at a desired speed of rotation. In this manner, a feedback loop is provided through combo 116, first servo 128, and second servo 130.

In different illustrative examples, one or more components within disk drive 100 may be implemented using circuits 162. Circuits 162 may be formed using integrated circuit technology. For example, at least one of hard disk controller 120, read channel 118, host connector 122, first servo 128, second servo 130, first preamplifier 142, second preamplifier 144, disk formatter 158, memory unit 160, and other components may be implemented using circuits 162 in the form of integrated circuits 164. Further, these different components may be located on the same integrated circuit or different integrated circuits within integrated circuits 164. An integrated circuit also may be referred to as a chip or microchip.

The illustration of disk drive 100 in FIG. 1 is not meant to imply physical or architectural limitations to the manner in which different illustrative embodiments may be implemented. Other components in addition to and/or in place of the ones illustrated may be used. Some components may be unnecessary in some illustrative embodiments. Also, the blocks are presented to illustrate some functional components. One or more of these blocks may be combined and/or divided into different blocks when implemented in different illustrative embodiments.

For example, in some illustrative embodiments, read channel 118 may be a separate component from hard disk controller 120. For example, read channel 118 may be a component external to hard disk controller 120 and connected to hard disk controller 120 on printed circuit board assembly 104. Further, in some illustrative embodiments, the different connections between different components may be made through optical connections rather than electrical connections, depending on the particular implementation. Further, in some illustrative examples, hardware modules may be present to implement various functions rather than using program code, depending on the particular implementation.

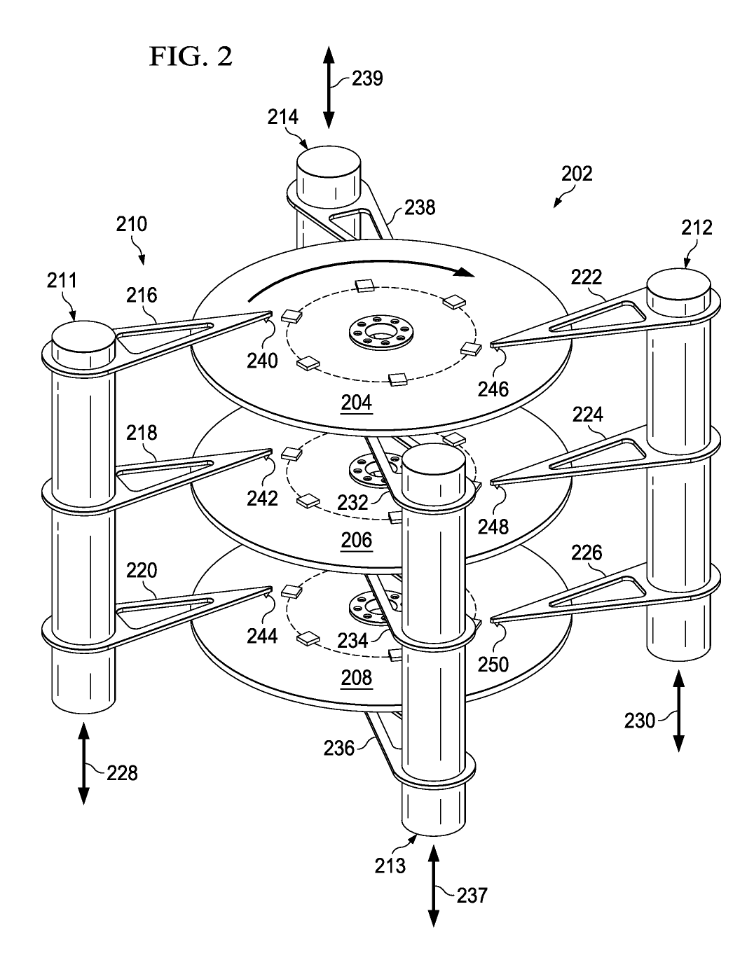

With reference now to FIG. 2, an illustration of actuator assemblies and magnetic disks in a disk drive is depicted in accordance with an illustrative embodiment. In this illustration, plurality of magnetic disks 202 is an example of one implementation for plurality of magnetic disks 106 in FIG. 1. Plurality of magnetic disks 202 comprises magnetic disk 204, magnetic disk 206, and magnetic disk 208. Actuator assemblies 210 are an example of one implementation for actuator assemblies 108 in FIG. 1.

Actuator assemblies 210 include first actuator assembly 211, second actuator assembly 212, third actuator assembly 213, and fourth actuator assembly 214. First actuator assembly 211 has arm 216, arm 218, and arm 220. In this illustrative example, arm 216, arm 218, and arm 220 may move about axis 228. Second actuator assembly 212 has arm 222, arm 224, and arm 226. Arm 222, arm 224, and arm 226 may move about axis 230.

Further, third actuator assembly 213 has arm 232, arm 234, and arm 236. As depicted arm 232, arm 234, and arm 236 may move about axis 237. Fourth actuator assembly 214 has arm 238 and two other arms (not shown in this view). Arm 238 and the other two arms may move about axis 239. Each arm in an actuator assembly may rotate independently of another arm in the same actuator assembly about the axis corresponding to the actuator assembly. For example, for third actuator assembly 213, arm 236 may rotate a first number of degrees, while arm 234 rotates a second number of degrees.

In this depicted example, arm 216 has read and write unit 240, arm 218 has read and write unit 242, arm 220 has read and write unit 244, arm 222 has read and write unit 246, arm 224 has read and write unit 248, and arm 226 has read and write unit 250. Additionally, arm 232, arm 234, arm 236, arm 238, and the two other arms for fourth actuator assembly 214 also have read and write units (not shown in this view).

Each actuator assembly may transfer data in different directions from other actuator assemblies. For example, first actuator assembly 211 may transfer data in a first direction, while second actuator assembly 212 transfers data in a second direction. Further, third actuator assembly 213 may transfer data in a direction different from fourth actuator assembly 214.

For example, read and write unit 240 on arm 216 may read data from magnetic disk 204, while read and write unit 246 on arm 222 writes data to magnetic disk 204. In yet another example, read and write unit 240 on arm 216 may write data to magnetic disk 204, while read and write unit 248 on arm 224 reads data from magnetic disk 206.

In the different illustrative examples, first actuator assembly 211 and second actuator assembly 212 are configured to transfer data on the same surface of a magnetic disk. Third actuator assembly 213 and fourth actuator assembly 214 are also configured to transfer data on the same surface of a magnetic disk. In particular, first actuator assembly 211 and second actuator assembly 212 are configured to transfer data on a first surface of a magnetic disk opposite to a second surface of the magnetic disk on which third actuator assembly 213 and fourth actuator assembly 213 are configured to transfer data.

For example, arm 216 of first actuator assembly 211 and arm 222 of second actuator assembly 212 may both read from and write to, respectively, the upper surface of magnetic disk 204. Arm 218 and arm 224 may both read from and write to, respectively, the upper surface of magnetic disk 206. Arm 220 and arm 226 may both read from and write to, respectively, the upper surface of magnetic disk 208. Similarly, arm 232 and arm 238 may both read from and write to, respectively, the lower surface of magnetic disk 204. Arm 234 and an arm for fourth actuator assembly 214 may both read from and write to, respectively, the lower surface of magnetic disk 206. Arm 236 and another arm for fourth actuator assembly 214 may both read from and write to, respectively, the lower surface of magnetic disk 208.

As one illustrative example, read and write unit 240 on arm 216 may read from the upper surface of magnetic disk 204 while the read and write unit on arm 238 may write to the lower surface of magnetic disk 204. As another example, read and write unit 242 on arm 218 may read from the upper surface of magnetic disk 206, while the read and write unit on arm 234 may read from the lower surface of magnetic disk 206. In some cases, the read and write unit on arm 236 may read from the lower surface of magnetic disk 208, while the read and write unit on an arm for fourth actuator assembly 214 writes to the lower surface of magnetic disk 208.

In this illustrative example, any number of read and write units for first actuator assembly 211, second actuator assembly 212, third actuator assembly 213, and fourth actuator assembly 214 may perform read or write operations on plurality of magnetic disks 202. In this manner, read and write operations may be performed on the same surface of the same magnetic disk, on two different surfaces of the same magnetic disk, or on two different magnetic disks in plurality of magnetic disks 202. Further, read and write operations may be performed at substantially the same time or at different times.

For example, the reading and writing of data on magnetic disk 204 by read and write unit 240 on arm 216 and read and write unit 234 on arm 246 may be started at substantially the same time. This type of start indicates that the read and write operations are performed synchronously and have a synchronous start. When the reading and writing of data on magnetic disk 204 stops at substantially the same time, the read and write operations have a synchronous stop. In other illustrative examples, the read and write operations may be performed at different times with different start times and/or stop times. In other words, these types of read and write operations are performed asynchronously.

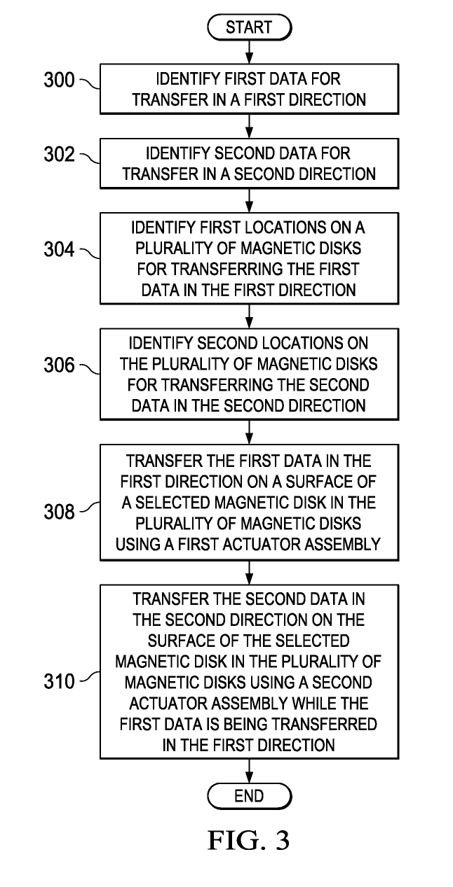

With reference now to FIG. 3, an illustration of a flowchart of a process for transferring data to and from magnetic disks is depicted in accordance with an illustrative embodiment. The process described in FIG. 3 may be implemented using hard disk controller 120 in FIG. 1. In particular, this process is implemented using hard disk controller 120 to transfer data 146 to and from plurality of magnetic disks 106 in FIG. 1.

The process begins by identifying first data for transfer in a first direction (step 300). Second data for transfer in a second direction is identified (step 302). First locations on a plurality of magnetic disks for transferring the first data in the first direction are identified (step 304). Second locations on the plurality of magnetic disks for transferring the second data in the second direction are identified (step 306).

The process then transfers the first data in the first direction on a surface of a selected magnetic disk in the plurality of magnetic disks using a first actuator assembly (step 308). Step 308 may occur with the process controlling the first actuator assembly to move a first read and write unit in the first actuator assembly to the first locations to transfer the first data in the first direction.

The process then transfers the second data in the second direction on the surface of the selected magnetic disk in the plurality of magnetic disks using a second actuator assembly, while the first data is being transferred in the first direction (step 310), with the process terminating thereafter. Step 310 may be performed by the hard disk controller causing a second actuator assembly to move a second read and write unit in the second actuator assembly to the second locations to transfer the second data in the second direction. In this manner, the transfer of first data in the first direction and the transfer of second data in the second direction may be performed simultaneously.

Thus, the different illustrative embodiments provide a method and apparatus for transferring data with magnetic disks in a hard disk drive. The disk drive comprises a plurality of magnetic disks; a first actuator assembly, and a second actuator assembly. The first actuator assembly is configured to transfer first data with the plurality of magnetic disks. The second actuator assembly is configured to transfer second data with the plurality of magnetic disks. The first actuator assembly transfers the first data in a first direction on a surface of a selected magnetic disk in the plurality of magnetic disks, while the second actuator assembly transfers the second data in a second direction on the surface of the selected magnetic disk in the plurality of magnetic disks.

In this manner, the transfer of data may be increased using one or more of the different illustrative embodiments. The increase in the transfer of data may occur while reducing the increase in the complexity of circuits, software, or other components in the hard disk drive.

The description of the illustrative embodiments has been presented for purposes of illustration and description, but is not intended to be exhaustive or limited to the invention in the form disclosed. Many modifications and variations will be apparent to those of ordinary skill in the art. The illustrative embodiment was chosen and described in order to best explain the principles of the invention and the practical application to enable others of ordinary skill in the art to understand the invention for various embodiments with various modifications as are suited to the particular use contemplated.

What is claimed is:

1. A disk drive comprising:
a plurality of magnetic disks;
a first actuator assembly configured to transfer first data with the plurality of magnetic disks; and
a second actuator assembly configured to transfer second data with the plurality of magnetic disks, wherein the first actuator assembly transfers the first data in a first direction on a surface of a selected magnetic disk in the plurality of magnetic disks while the second actuator assembly transfers the second data in a second direction on the surface of the selected magnetic disk in the plurality of magnetic disks.

2. The disk drive of claim 1, wherein the first actuator assembly transfers the first data in the first direction for a first magnetic disk in the plurality of magnetic disks while the second actuator assembly transfers the second data in the second direction for a second magnetic disk in the plurality of magnetic disks.

3. The disk drive of claim 1, wherein the first actuator assembly moves a first number of arms about a first axis and the second actuator assembly moves a second number of arms about a second axis.

4. The disk drive of claim 1 further comprising:
a first preamplifier connected to the first actuator assembly; and
a second preamplifier connected to the second actuator assembly.

5. The disk drive of claim 1, wherein the first actuator assembly comprises a first number of arms and a first number of read and write units and the second actuator assembly comprises a second number of arms and a second number of read and write units.

6. The disk drive of claim 1 further comprising:
a read channel connected to the first actuator assembly and the second actuator assembly.

7. The disk drive of claim 4 further comprising:
a read channel connected to the first preamplifier and the second preamplifier.

8. The disk drive of claim 6 further comprising:
a disk formatter connected to the read channel.

9. The disk drive of claim 1 further comprising:
a positioning system configured to control a position of the first actuator assembly and a position of the second actuator assembly relative to the plurality of magnetic disks.

10. The disk drive of claim 1 further comprising:
a hard disk controller configured to control transfer of the first data in the first direction using the first actuator assembly and transfer of the second data in the second direction using the second actuator assembly.

11. The disk drive of claim 10, wherein the hard disk controller comprises:
a read channel;
a positioning system connected to the read channel, the first actuator assembly, and the second actuator assembly, wherein the positioning system is configured to control the first actuator assembly and the second actuator assembly;
a disk formatter connected to the read channel;
a memory unit connected to the disk formatter; and
a host interface connected to the memory unit.

12. The disk drive of claim 10, wherein the hard disk controller comprises an integrated circuit.

13. An apparatus comprising:
a number of circuits configured to control transfer of first data in a first direction on a surface of a selected magnetic disk in a plurality of magnetic disks using a first actuator assembly and transfer of second data in a second direction on the surface of the selected magnetic disk in the plurality of magnetic disks using a second actuator assembly.

14. The apparatus of claim 13, wherein the number of circuits is embodied on an integrated circuit.

15. The apparatus of claim 14, wherein the integrated circuit is a hard disk controller.

16. The apparatus of claim 14, wherein the integrated circuit is for a disk formatter.

17. A method for transferring data, the method comprising:
transferring first data in a first direction on a surface of a selected magnetic disk in a plurality of magnetic disks using a first actuator assembly; and
transferring second data in a second direction on the surface of the selected magnetic disk in the plurality of magnetic disks using a second actuator assembly, while the first data is being transferred in the first direction by the first actuator assembly.

18. The method of claim 17 further comprising:
identifying the first data for transfer in the first direction;
identifying the second data for transfer in the second direction;
identifying first locations on the plurality of magnetic disks for transferring the first data in the first direction;
identifying second locations on the plurality of magnetic disks for transferring the second data in the second direction.

19. The method of claim 18 further comprising:
moving a first read and write unit in the first actuator assembly to the first locations to transfer the first data in the first direction; and
moving a second read and write unit in the second actuator assembly to the second locations to transfer the second data in the second direction.

20. The method of claim 17, wherein the first actuator assembly comprises a first number of arms and a first number of read and write units and the second actuator assembly comprises a second number of arms and a second number of read and write units.
